(19) United States
(12) Patent Application Publication
(10) Pub. No.: US 2011/0305865 A1
(43) Pub. Date: Dec. 15, 2011

(54) SOUND-DAMPENING POLYURETHANE-BASED COMPOSITE

(75) Inventors: Carlo Cocconi, Correggio (IT); Antonio Grieco, Correggio (IT); Gianluca Casagrande, Castelfranco Emillia (IT)

(73) Assignee: Dow Global Technologies Inc. (Formerly Known as Dow Global Technologies Inc.), Midland, MI (US)

(21) Appl. No.: 13/203,551

(22) PCT Filed: Feb. 3, 2010
(86) PCT No.: PCT/US2010/023028

§ 371 Date: Aug. 26, 2011

Related U.S. Application Data
(60) Provisional application No. 61/157,434, filed on Mar. 4, 2009.

(51) Int. Cl. B32B 5/20; B32B 5/24; B32B 27/40; B32B 7/04; B05D 5/00; B05D 1/36

(52) U.S. Cl. 428/97; 427/244; 428/319.3; 442/1; 442/30; 442/56

(57) ABSTRACT

A sound- and vibration-dampening (NVH) layered composition may be prepared by spraying or spray-foaming a polyurethane heavy layer, and spray-foaming a flexible polyurethane foam layer, under conditions such that the two layers bond integrally with one another without use of glue or other adhesive. Additional layers, that are the same as, or different from, these two layers may also be included in the composition. The layered composition may be used in, for example, automotive applications. The method is faster and requires less hardware and space than conventional methods that include gluing steps or employ heavy molds to withstand the pressures generated therein by methods such as injecting or pouring; however, it may still attain relatively uniform thicknesses even when spraying is done on a substrate that does not become part of the final construction.

### BACKGROUND OF THE INVENTION

1. Technical Field

This invention relates to the field of polyurethanes used to modify noise and vibration primarily for automotive applications. More particularly, it relates to compositions and processes for preparing a sprayed polyurethane-based composite for vehicular applications.

2. Background of the Art

It is customary in the automotive industry to include in each vehicle various means of reducing or otherwise modifying noise and vibration, in order to ensure a more comfortable ride for the consumer. One means of accomplishing this is to strategically deploy specially-designed materials in the engine compartment, the passenger compartment, and at certain other locations in the vehicle. These materials are referred to as “NVH” materials. “NVH” stands for “noise and vibration harshness,” which is what is controlled or modified by the materials.

Conventionally, NVH materials comprise at least two layers. These layers include an absorbing layer and a deflecting layer. The absorbing layer is aligned within the vehicle to face the source of the noise and/or vibration, while the deflecting layer functionally “backs” the absorbing layer, such that any noise or vibration that is not absorbed, is deflected back toward the source, i.e., it does not pass through the deflecting material. The choice of materials for these layers affects their performance.

The deflecting layer is frequently termed the “heavy layer,” and is typically prepared from high density materials such as ethylene propylene diene monomer (EPDM) or ethylene vinyl acetate (EVA) blends with bitumen, with or without inorganic fillers. The high density material is typically thermoformed, in the shape of the final vehicle part, on a foil substrate. While polyurethanes have not enjoyed wide use in this application, they have been occasionally employed as high density materials that include a filler, such as barium sulfate or another inorganic. This polyurethane heavy layer is prepared by injecting, pouring, or spraying the polyurethane into a relatively heavy mold that includes a lid. This mold has been preformed to the shape of the vehicle floor or engine compartment for which the polyurethane composite is ultimately destined. A second polyurethane absorbing layer may then be backfoamed, either by pouring or injecting a suitable polyurethane foam formulation into the mold, over the heavy layer. The mold is then quickly closed and the composite is allowed to foam and substantially cure therein. Because the top of the lid helps to ensure that all portions of the composite are of substantially the desired thickness(es) throughout their surface planes, the mold must be able to withstand substantial pressure resulting from the reactions occurring within it.

Various other approaches to sound attenuating materials have been developed for use in reducing noise levels within passenger compartments of vehicles. For example, U.S. Pat. No. 4,374,172 to Schwarz et al. describes a “sound damping” material in the shape of foils or strips comprising open-pored foam material impregnated with different quantities of a viscoelastic compound. This is intended for vehicle structures such as body panels.

U.S. Pat. No. 4,851,283 to Holtrop et al., proposes a thermoformable laminate for use in headliners. The headliner comprises a non-woven fabric that is bonded to a foamed polymer sheet. The fabric is formed from a blend of low melting and high melting staple fibers.

U.S. Pat. No. 5,298,694 to Thompson proposes a non-woven acoustical insulation web. The web comprises thermoplastic fibers, and particularly a blend of melt-blown microfibers and crimped bulking fibers.

U.S. Pat. No. 6,382,350 to Jezewski et al. is directed to molded acoustic and decorative mats including a base layer having an exposure hole; a face layer; and an acoustic absorbing layer, with the acoustic absorbing layer including an exposed portion extending across the exposure hole such that the base layer is bonded to the acoustic absorbing layer. The face layer is preferably a carpet material; the base layer is preferably an elastomeric or thermoplastic material; and the acoustic absorbing layer may be a polyurethane, polypropylene, or polyethylene.

U.S. Pat. No. 6,821,366 to Allison et al. describes porous carpeting for vehicles that is prepared by heating a carpet backing to achieve a fluid or semi-fluid state and then subjecting it to an intense vacuum to draw air through the carpet backing, thereby creating a porous structure. A layer of porous thermoformable material may be applied to the porous carpet structure for mechanical strength.

U.S. Pat. No. 7,097,723 to Allison et al. describes lightweight acoustic automobile carpet wherein porous carpeting is backed by a primary sound reducing layer and localized secondary insulators. The porous carpet structure is heated to achieve a fluid or semi-fluid state, and then a vacuum is drawn to create a porous structure. Finally, a layer of sound absorbing or insulating material is applied to the porous carpet structure for improved acoustic properties. Secondary sound reducing absorbers/insulators may be further included as part of the molding process to provide selected areas of increased thickness and, therefore, tailoring of sound attenuation.

U.S. Pat. No. 7,226,879 B2 discloses a multidensity liner/insulator formed from multidimensional pieces of polymer fiber blanket insulation. The polymer fiber blanket is constructed of a plurality of individual pieces of polymer fiber blanket that have been bonded together via heat and pressure.

WO 2007017422 (A3) discloses a manufacturing process to prepare a sound insulation panel. The process includes spraying a first, non-expanded compact material on the inner surface of a mold, then injecting a second, expanded material into the mold to produce a panel. The process requires a control means to adjust the spraying of the first material.

While some of the above, and other art-known, methods may provide a measure of sound- and/or vibration-dampening, many suffer drawbacks that have led those in the art to continue to search for other means to accomplish this goal. Many prior art approaches require use of molds that are able to withstand the relatively high pressures involved in injecting or pouring into molds; many require expensive and inconvenient heating steps; and many require a multitude of steps that must be carried out at different stations, thereby requiring equipment that occupies a relatively large “footprint” area in a manufacturing facility. Thus, what is needed in the art is a means of sound- and/or vibration-dampening that is convenient and economical to produce; that requires neither expensive, high-pressure molds, nor a large “footprint” area for production; and that may be tailored to assure substantially the same thickness throughout the surface planes.

### SUMMARY OF THE INVENTION

Accordingly, the present invention provides, in one aspect, a method of preparing a layered composition comprising, in non-ordered steps, spraying or spray-foaming at least one polyurethane heavy layer, and spray-foaming at least one flexible polyurethane foam layer; under conditions such that an integral layered composition is formed without use of an adhesive between the at least one polyurethane heavy layer and the at least one flexible polyurethane foam layer. It may be prepared in a relatively lightweight and/or complex mold, with or without a lid, e.g., a one-part or two-part mold; or adhered or integrally bonded to a substrate; or on a surface that does not become part of the composition. The mold or substrate may itself be of planar or non-planar, i.e., complex, shape, and thus the final layered composition may be planar or of a complex shape. Either or both of the steps may be repeated an indefinite number of times to make a multilayered composition, and in another embodiment, one or more layers of dissimilar materials, such as metal foils, other thermoset materials, thermoplastic materials, or various natural and/or composite materials, may optionally also be included in the layered composition.

In another aspect, the invention provides a layered composition prepared by a method comprising, in non-ordered steps, spraying or spray-foaming at least one polyurethane heavy layer, and spray-foaming at least one flexible polyurethane foam layer; under conditions such that an integral layered composition is formed without use of adhesive between the layers. In certain embodiments the layered composition as a whole is of substantially the same thickness throughout, and in other embodiments each individual layer is of substantially the same thickness throughout. In other embodiments the layered composition may have varying and specifically designed thicknesses within any given layer, as desired. The integral layered composition may comprise one or more additional layers that are the same as, or different from, the polyurethane heavy layer or the flexible polyurethane foam layer. The layered composition is suitable for use as an NVH material.

In yet another aspect, the invention provides a layered composition comprising at least one polyurethane heavy layer and, bonded integrally thereto without use of an adhesive, at least one flexible polyurethane foam layer. The integral layered composition may comprise one or more additional layers that are the same as, or different from, the polyurethane heavy layer or the flexible polyurethane foam layer. The layered composition has sound- and vibration-dampening properties.

### DETAILED DESCRIPTION OF THE INVENTION

The invention provides a layered composition having improved NVH performance when used for vehicle passenger or engine compartments, as well as in other potential uses. Each of the layers serves a particular purpose, and production of the composition may be more convenient and less expensive than many of the alternative approaches to the NVH problem in vehicles.

The first layer to be described is the polyurethane heavy layer. This layer is defined as comprising a polyurethane polymer, frequently a filled foam, which is effective in deflecting noise and/or vibration. As used herein, “noise” represents air movements occurring at frequencies that are perceived as audible to humans, and “vibration” represents movements of air or of any other material that are perceived via the human sense of touch. In certain non-limiting embodiments, the polyurethane heavy layer has a relatively high fluid resistance. This property, fluid resistance, may be used to determine whether a material is suitable for NVH purposes. Thus, a material having a relatively high fluid resistance can be roughly translated as being one that is “more” effective at deflecting sound and/or vibration than is a material having a relatively low fluid resistance. This is because the flow of any fluid, such as air, against, into, or through a material is directly related to the potential movement of sound (noise) and of vibrations with respect to that material.

The polyurethane heavy layer may attain its relatively high fluid resistance via a relatively high density or full density of the polyurethane itself and/or the use of fillers. Suitable fillers for this purpose include carbon black, natural mineral fillers, synthetic mineral fillers, wood flour, and combinations thereof. Among these are, for example, inorganic oxides, sulfates, silicates, clays, talc, carbonates, wollastonite, titanates, and combinations thereof, as well as recycled, comminuted, non-foamed and/or high density foamed polyurethanes. In some embodiments marble dust and/or barium sulfate may also or alternatively be employed. Such fillers are not chemically bonded into the polyurethane heavy layer, and are, instead, mechanically trapped within its structure. Other suitable fillers include ground and/or recycled material from another layered composition of the invention or any part thereof, or from another NVH composite prepared by a different process. Such materials, particularly those that are recycled, may themselves already contain fillers such as those listed hereinabove.

Where filler is included in the polyurethane heavy layer, the proportion of the filler may range from about 10 percent to about 95 percent by weight, based on the polyurethane heavy layer as a whole. In some non-limiting embodiments it may range from about 15 percent to about 90 percent by weight. In other non-limiting embodiments it may range from about 20 percent to about 85 percent by weight.

In certain non-limiting embodiments, the density of the polyurethane heavy layer as a whole, whether filled or unfilled, ranges from about 500 kg/m³ to about 9000 kg/m³. In other non-limiting embodiments, it ranges from about 550 kg/m³ to about 8000 kg/m³. In yet other non-limiting embodiments, it ranges from about 600 kg/m³ to about 7000 kg/m³. While the polyurethane heavy layer may be, in some embodiments, a foam, it is preferably a full density solid, having a density of about 1250 kg/m³, and may be either flexible or rigid. Frequently a full density polyurethane is prepared, or if a minor amount of expansion is desired, a relatively small amount of a blowing agent may be incorporated in the polymerization mixture from which the polyurethane heavy layer is formed.

The particularly convenient and time-saving method of preparing the polyurethane heavy layer in the present invention is via spray or spray-foam application. Where spray-foaming is selected, such may be accomplished using conventional spray-foaming equipment, such as may be available from commercial manufacturers including, for example, Krauss-Maffei, Cannon, and Isoterm. In certain non-limiting embodiments, a conventional, robotic plural component spray gun may be used, wherein the isocyanate and resin (polyol) components of the polyurethane are simultaneously mixed together, combined (if desired) with an appropriate blowing agent and/or air, and sprayed, as a liquid or as a foam, into the mold. An appropriate release agent may be used, or in alternative non-limiting embodiments, a scrim layer, for example, a textile vehicle carpeting, may be placed into the mold first or simply used as a substrate, and the polyurethane heavy layer may then be sprayed or spray-foamed on top of or against it. As the polyurethane-forming components react, the resulting polyurethane polymer forms.

Plural component spray guns useful in the method of the invention are typically manufactured with mesh pump and gun screens. For preparing a polyurethane heavy layer for automotive NVH purposes, it is, in some non-limiting embodiments, desirable to use a relatively large screen mesh size, particularly if the polyurethane heavy layer includes filler that may tend to clog smaller screens. Those skilled in the art will be already familiar with appropriate equipment, operating parameters, and spraying rates and methods, or will be able to easily discern such by means of only routine experimentation.

Once the polyurethane heavy layer formulation has been sprayed or spray-foamed and formation of the layer is completed, but desirably before the polymer has time to complete polymerization and cure, a flexible polyurethane foam layer may be spray-foamed on top of it or against it, according to the desired relationship of the layers to one another as well as the spatial orientations of any equipment being used. However, it is important to note that the steps of forming the polyurethane heavy layer and the flexible polyurethane foam layer are “non-ordered,” meaning that it is also within the scope of the invention to form the flexible polyurethane foam layer first, and then spray or spray-foam the polyurethane heavy layer thereafter. Either protocol represents an embodiment of the invention, and in other embodiments one or both of the non-ordered steps may be repeated to produce a multi-layered construction, with or without inclusion of additional similar or dissimilar layers, as desired. Regardless of which layer is formed second, it is applied under conditions such that it attaches “integrally” to the first-formed layer. Thus, the layered composition is “integral,” which means that the attachment is between the layers themselves, without use of glue or other adhesives of any kind. This is in contrast to certain conventional methods of preparing NVH materials, which generally form layers in separate steps and at different locations within a manufacturing facility, and then glue them together. The present invention's spray and/or spray-foam applications provide a more convenient, efficient, rapid, and controlled method than the conventional use of separate moldings for each layer and/or of relatively heavy, expensive molds that can withstand the pressures generated during polymerization of injected or poured foam formulations.

To form the flexible polyurethane foam layer, often but not necessarily as a second layer, appropriate component selections are made for the plural component spray or spray-foam gun. Isocyanate, resin and blowing agent selections are desirably geared toward preparing a material that is somewhat less dense, i.e., less fluid-resistant, than the formulation used for the polyurethane heavy layer. Fillers are generally avoided for this secondary layer, though in some embodiments a relatively small amount of one or more traditional fillers may be used, and the result is generally designed to be an open-celled foam having a relatively lower overall density than that of the polyurethane heavy layer. Such density ranges, in some non-limiting embodiments, from about 15 kg/m³ to about 250 kg/m³. In other non-limiting embodiments, it ranges from about 20 kg/m³ to about 200 kg/m³. In yet other non-limiting embodiments, it ranges from about 25 kg/m³ to about 175 kg/m³. The flexible polyurethane foam layer may serve as an effective noise- and vibration-absorbant, which, when used in tandem with the polyurethane heavy layer, serves to absorb a portion of the noise and vibration to which it is exposed, both as the noise and vibration moves from its source toward the polyurethane heavy layer, and as any of the as-yet unabsorbed portion of the noise and vibration is deflected back from the polyurethane heavy layer and into the flexible polyurethane foam layer again.

An advantage of the present method is that, in many non-limiting and commercial embodiments, the flexible polyurethane foam layer may be spray-foamed immediately prior to or after spraying or spray-foaming the polyurethane heavy layer. This enables the two layers to bond together well, while at the same time reducing overall manufacturing time and, therefore, costs. However, in other non-limiting embodiments, it is alternatively possible to allow the polyurethane heavy layer to complete some or all of its polymerization and cooling processes before spray-foaming the flexible polyurethane foam layer. In this case the flexible polyurethane foam layer will still bond with the polyurethane heavy layer, and thus, no glue or other adhesive will be needed.

Those skilled in the art will be easily able to carry out the final cooling and, if applicable, removal of the NVH composite of the invention from the mold, where a mold has been used, without further direction. If a mold has not been used during the spray or spray-foam application, it is, in some non-limiting alternative embodiments, possible to cut and/or shape the composite as a whole after the second layer has been formed, desirably after both layers have completed polymerization and, in some embodiments, at least a portion of any final cure as required for a given formulation. Importantly, because the layers are sprayed or spray-foamed, it may be possible to use a non-lidded mold and/or a mold with a relatively lightweight lid that does not require time-consuming and expensive pressure-resistant clamping, and still obtain a layered composition having layers of desired thickness or thicknesses, i.e., that have relatively parallel planar surfaces at any given, discrete location. Such thickness control may further apply even where complex, generally non-planar final shapes are being sought, or where the spraying is done without a mold or a substrate that will become a part of the final layered composition. For example, spraying and/or spray-foaming may, in some embodiments, be done on a conveyor device, for example, in a continuous manner and, in some embodiments, using an appropriate release agent on the conveyor device, with the integrally-bonded, layered composition then removed therefrom.

Where a scrim is employed, in an alternative non-limiting embodiment of the invention, such may be, for example, a woven, nonwoven, or tufted textile. For example, a tufted carpet is, itself, a composite structure in which tufts, or bundles of aligned textile fibers, are secured in a primary backing, frequently by a means such as by stitching or needling. This backing may itself be a woven or non-woven textile. A secondary backing or coating, generally of a thermoplastic material, has generally been applied to the underside of the carpet structure in order to securely retain the tufted material in the primary backing. This secondary backing serves to not only dimensionally stabilize the carpet construction, but may also provide greater abrasion and wear resistance, and may, in some embodiments, also serve as an adhesive to the layered composition of the invention. In contrast, nonwoven carpet is composed of fiber that is mechanically entangled by needling, water jet, or another process, rather than aligned into tufting bundles. For purposes of the present discussion, any and all such textiles, regardless of the number of layers or construction comprised therein, are included within the generalized term “scrim.”

The formulations for both of the described polyurethane layers may include certain typical polyurethane components, and may optionally include a number of additives or other modifiers. The first is a polyisocyanate component. This is referred to in the United States as the “A-component” (in Europe, as the “B-component”). Selection of the A-component may be made from a wide variety of polyisocyanates, including but not limited to those which are well known to those skilled in the art. For example, organic polyisocyanates, modified polyisocyanates, isocyanate-based prepolymers, and mixtures thereof may be employed. These may further include aliphatic and cycloaliphatic isocyanates, and in particular aromatic, especially multifunctional aromatic isocyanates. Also particularly preferred are polyphenyl polymethylene polyisocyanates (PMDI).

Other polyisocyanates that may be useful in the present invention include 2,4- and 2,6-toluenediisocyanate and the corresponding isomeric mixtures; 4,4′-, 2,4′- and 2,2′-diphenyl-methanediisocyanate and the corresponding isomeric mixtures; mixtures of 4,4′-, 2,4′- and 2,2′-diphenyl-methanediisocyanates and polyphenyl polymethylene polyisocyanates (PMDI); and mixtures of PMDI and toluene diisocyanates. Also useful for preparing the polyurethane layers of the present invention are aliphatic and cycloaliphatic isocyanate compounds such as 1,6-hexamethylene-diisocyanate; 1-isocyanato-3,5,5-trimethyl-1,3-isocyanatomethyl-cyclohexane; 2,4- and 2,6-hexahydro-toluene-diisocyanate, as well as the corresponding isomeric mixtures; 4,4′-, 2,2′- and 2,4′-dicyclohexylmethanediiso-cyanate, as well as the corresponding isomeric mixtures. Also useful is 1,3-tetramethylene xylene diisocyanate. In certain embodiments, the polyisocyanate is PMDI.

Also advantageously used for the A-component are the so-called modified multifunctional isocyanates, that is, products which are obtained through chemical reactions of the above diisocyanates and/or polyisocyanates. Exemplary are polyisocyanates containing esters, ureas, biurets, allophanates and, preferably, carbodiimides and/or uretonomines, and isocyanurate and/or urethane group containing diisocyanates or polyisocyanates. Liquid polyisocyanates containing carbodiimide groups, uretonomine groups and/or isocyanurate rings, having isocyanate group (NCO) contents of from 15 to 50 weight percent, more preferably from 20 to 45 weight percent, may also be used. These include, for example, polyisocyanates based on 4,4′-, 2,4′- and/or 2,2′-diphenylmethane diisocyanate and the corresponding isomeric mixtures; 2,4- and/or 2,6-toluenediiso-cyanate and the corresponding isomeric mixtures; mixtures of diphenylmethane diisocyanates and PMDI; and mixtures of toluenediisocyanates and PMDI and/or diphenylmethane diisocyanates.

Suitable prepolymers for use as the polyisocyanate component of the formulations of the present invention include those having NCO contents of from 2 to 45 weight percent, more preferably from 4 to 40 weight percent. These prepolymers are prepared by reaction of the di- and/or poly-isocyanates with materials including lower molecular weight diols and triols, but may alternatively be prepared with multivalent active hydrogen compounds, such as di- and tri-amines and di- and tri-thiols. Individual examples are aromatic polyisocyanates containing urethane groups, preferably having NCO contents of from 5 to 48 weight percent, more preferably 20 to 45 weight percent, obtained by reaction of diisocyanates and/or polyisocyanates with, for example, lower molecular weight diols, triols, oxyalkylene glycols, dioxyalkylene glycols, or polyoxyalkylene glycols having molecular weights up to about 3000. These polyols may be employed individually or in mixtures as di- and/or polyoxyalkylene glycols. For example, diethylene glycols, dipropylene glycols, polyoxyethylene glycols, ethylene glycols, propylene glycols, butylene glycols, polyoxypropylene glycols and polyoxypropylene-polyoxyethylene glycols may be used. Polyester polyols may also be used, as well as alkyl diols such as butane diol. Other useful diols may include bishydroxyethyl- and bishydroxypropyl-bisphenol A, cyclohexane dimethanol, and bishydroxyethyl hydroquinone.

Useful as the polyisocyanate component of useful prepolymer formulations are: (i) polyisocyanates having an NCO content of from 2 to 40 weight percent containing carbodiimide groups and/or urethane groups, from 4,4′-diphenylmethane diisocyanate or a mixture of 4,4′- and 2,4′-diphenylmethane diisocyanates; (ii) prepolymers containing NCO groups, having an NCO content of from 2 to 35 weight percent, based on the weight of the prepolymer, prepared by the reaction of polyols, having a functionality of preferably from 1.75 to 4 and a molecular weight of from 200 to 15,000, with 4,4′-diphenylmethane diisocyanate or with a mixture of 4,4′- and 2,4′-diphenylmethane diisocyanates; mixtures of (i) and (ii); and (iii) 2,4′ and 2,6-toluene-diisocyanate and the corresponding isomeric mixtures.

PMDI in any of its forms is the most preferred polyisocyanate for use with the present invention. When used, it preferably has an equivalent weight between 125 and 300, more preferably from 130 to 175, and an average functionality of greater than about 1.5. More preferred is an average functionality of from 1.75 to 3.5. The viscosity of the polyisocyanate component is preferably from 25 to 5,000 centipoise (cP) (0.025 to about 5 Pa*s), but values from 50 to 1500 cP at 25° C. (0.05 to 1.5 Pa*s) may be preferred for ease of processing. Similar viscosities are preferred where alternative polyisocyanate components are selected. In particular but non-limiting embodiments, the polyisocyanate component is selected from the group consisting of MDI, PMDI, an MDI prepolymer, a PMDI prepolymer, a modified MDI, and mixtures thereof.

The B-component (in the U.S.; the A-component in Europe) of the foam-forming formulation is a polyol or polyol system which may comprise polyols that contain at least two reactive hydrogen atoms in a hydroxyl group. Such polyols may be polyether polyols or polyester polyols, may be aromatic, aliphatic, or a combination thereof, and may be prepared using any suitable initiator, such as an amine. The selected polyol or polyols generally have a functionality of from 2 to 8, preferably 2 to 6, and an average hydroxyl number preferably from about 18 to about 2000, more preferably from about 20 to about 1810. The polyol or polyols may have a viscosity at 25° C. of at least about 500 cP, as measured according to ASTM D455. In some embodiments, a higher viscosity, of at least about 2,000 cP, may be preferable. An upper viscosity limit may be dictated by practicality and spraying and/or spray-foaming equipment limitations, but for most purposes a polyol or polyol system viscosity of less than about 20,000 cP, and more typically less than about 15,000 cP, is generally suitable.

Non-limiting examples of the polyols which may be useful are polythio-ether-polyols, polyester-amides, and hydroxyl-containing polyacetals and hydroxyl-containing aliphatic polycarbonates. Other selections may include mixtures of at least two of the above-mentioned polyhydroxyl compounds, alternatively further including polyhydroxyl compounds having hydroxyl numbers of less than 100. A few non-limiting examples may include polyols based on styrene-acrylonitrile (SAN) copolymers, polyisocyanate-poly-addition (PIPA) copolymers, poly(hydroxyethyl methacrylate-co-dimethylaminoethyl methacrylate) (PHD) copolymers, and the like.

Suitable polyester-polyols may be prepared from, for example, organic dicarboxylic acids having from about 2 to about 12 carbon atoms, preferably aromatic dicarboxylic acids having from 8 to 12 carbon atoms and polyhydric alcohols, preferably diols having from 2 to 12 carbon atoms, preferably from 2 to 6 carbon atoms. Examples of suitable dicarboxylic acids are succinic acid, glutaric acid, adipic acid, suberic acid, azelaic acid, sebacic acid, decanedicarboxylic acid, maleic acid, fumaric acid, and preferably phthalic acid, isophthalic acid, terephthalic acid and the isomeric naphthalene-dicarboxylic acids. The dicarboxylic acids may be used either individually or mixed with one another. The free dicarboxylic acids may also be replaced by the corresponding dicarboxylic acid derivatives, for example, dicarboxylic esters of alcohols having 1 to 4 carbon atoms or dicarboxylic anhydrides. Preference is given to dicarboxylic acid mixtures comprising succinic acid, glutaric acid and adipic acid in ratios of, for example, from 20 to 35:35 to 50:20 to 32 parts by weight, respectively, and mixtures of phthalic acid and/or phthalic anhydride and adipic acid; mixtures of phthalic acid or phthalic anhydride, isophthalic acid and adipic acid or dicarboxylic acid; mixtures of succinic acid, glutaric acid and adipic acid; mixtures of terephthalic acid and adipic acid or dicarboxylic acid; and mixtures of succinic acid, glutaric acid and adipic acid. Examples of dihydric and polyhydric alcohols, in particular diols, include ethanediol, diethylene glycol, 1,2- and 1,3-propanediol, dipropylene glycol, 1,4-butanediol, 1,5-pentanediol, 1,6-hexanediol, 1,10-decanediol, glycerol, and trimethylol-propane. Preference may be given to ethanediol, diethylene glycol, 1,4-butanediol, 1,5-pentanediol, 1,6-hexanediol, and mixtures of at least two of said diols, and in particular, mixtures of 1,4-butanediol, 1,5-pentanediol and 1,6-hexanediol. Furthermore, polyester-polyols made from lactones, for example, ε-caprolactone, or from hydroxy-carboxylic acids, for example, w-hydroxycaproic acid or hydrobenzoic acid, may also be employed.

The polyester-polyols may be prepared by polycondensing the organic, for example, aliphatic and preferably aromatic polycarboxylic acids and mixtures of aromatic and aliphatic polycarboxylic acids, and/or derivatives thereof, and polyhydric alcohols. This may be accomplished either without a catalyst or, preferably, with an esterification catalyst. An inert gas atmosphere, for example, nitrogen, carbon monoxide, helium, or argon, may facilitate preparation, which is effectively carried out in a melt phase at from about 150 to about 250° C., preferably from 180 to 220° C., and at atmospheric pressure or under reduced pressure, until the desired acid number, which is advantageously less than 10, preferably less than 2, is reached. In a preferred embodiment, the esterification mixture is polycondensed at the above-mentioned temperatures at atmospheric pressure and subsequently under a pressure of less than 500 mbar, preferably from 50 to 150 mbar, until an acid number of from 80 to 30, preferably from 40 to 30, has been reached. Examples of suitable esterification catalysts are iron, cadmium, cobalt, lead, zinc, antimony, magnesium, titanium and tin in the form of metals, metal oxides or metal salts. However, the polycondensation may also be carried out in the liquid phase in the presence of diluents and/or entrainers, for example, benzene, toluene, xylene or chlorobenzene, for removal of the water of condensation by azeotropic distillation.

The polyester-polyols are advantageously prepared by polycondensing the organic polycarboxylic acids and/or derivatives thereof with polyhydric alcohols in a molar ratio of from 1:1 to 1:1.8, preferably from 1:1.05 to 1:1.2. The polyester-polyols preferably have a functionality of from 2 to 5 and a hydroxyl number of from 20 to 600, and in particular, from 25 to 550.

Where polyether-polyols are selected, such may be prepared by known processes. For example, anionic polymerization, using alkali metal hydroxides such as sodium hydroxide or potassium hydroxide, or alkali metal alkoxides, such as sodium methoxide, sodium ethoxide, potassium ethoxide or potassium isopropoxide as catalyst and with addition of at least one initiator molecule containing from 2 to 8, preferably 3 to 8, reactive hydrogen atoms in bound form, may be employed. Alternatively, such may be prepared by cationic polymerization using Lewis acids, such as antimony pentachloride, boron fluoride etherate, inter alia, or bleaching earth as catalysts, from one or more alkylene oxides having from 2 to 4 carbon atoms in the alkylene moiety.

Non-limiting examples of suitable alkylene oxides are tetrahydrofuran, 1,3-propylene oxide, 1,2- and 2,3-butylene oxide, styrene oxide and, preferably, ethylene oxide and 1,2-propylene oxide. The alkylene oxides may be used individually, alternatively one after the other, or as mixtures. Examples of suitable initiator molecules are water, organic dicarboxylic acids such as succinic acid, adipic acid, phthalic acid and terephthalic acid, and a variety of amines, including but not limited to aliphatic and aromatic, unsubstituted or N-mono-, N,N- and N,N′-dialkyl-substituted diamines having from 1 to 4 carbon atoms in the alkyl moiety, such as unsubstituted or mono- or dialkyl-substituted ethylenediamine, diethylenetriamine, triethylenetetramine, 1,3-propylenediamine, 1,3- and 1,4-butylene-diamine, 1,2-, 1,3-, 1,4-, 1,5- and 1,6-hexamethylenediamine, aniline, phenylenediamines, 2,3-, 2,4-, 3,4- and 2,6-tolylenediamine, and 4,4′-, 2,4′- and 2,2′-diaminodiphenylmethane.

Other suitable initiator molecules are alkanolamines, for example, ethanolamine, N-methyl- and N-ethylethanolamine; dialkanolamines, for example, diethanolamine, N-methyl- and N-ethyldiethanolamine, and trialkanolamines, for example, triethanolamine and ammonia; and polyhydric alcohols, in particular dihydric and/or trihydric alcohols, such as ethanediol, 1,2- and 1,3-propanediol, diethylene glycol, dipropylene glycol, 1,4-butane-diol, 1,6-hexanediol, glycerol, trimethylolpropane, pentaerythritol, sorbitol and sucrose, polyhydric phenols, for example, 4,4′-dihydroxydiphenylmethane and 4,4′-dihydroxy-2,2-diphenylpropane, resols, for example, oligomeric products of the condensation of phenol and formaldehyde, and Mannich condensates of phenols, formaldehyde and dialkanolamines, and melamine.

It is advantageous, in some non-limiting embodiments, that the polyols are polyether-polyols having a functionality of from 2 to 8 and a hydroxyl number of from 100 to 850, prepared by anionic polyaddition of at least one alkylene oxide, preferably ethylene oxide or 1,2-propylene oxide or 1,2-propylene oxide and ethylene oxide, onto, as an initiator molecule, at least one aromatic compound containing at least two reactive hydrogen atoms and also at least one hydroxyl, amino and/or carboxyl group. Examples of such initiator molecules are aromatic polycarboxylic acids, for example, hemimellitic acid, trimellitic acid, trimesic acid and preferably phthalic acid, isophthalic acid and terephthalic acid; mixtures of at least two of the polycarboxylic acids; and hydroxycarboxylic acids, for example, salicylic acid, p- and m-hydroxybenzoic acid and gallic acid. Aminocarboxylic acids, for example, anthranilic acid, m- and p-aminobenzoic acid, may be used, as well as polyphenols, for example, resorcinol, and preferably dihydroxydiphenylmethanes and dihydroxy-2,2-diphenylpropanes. Other possibilities include Mannich condensates of phenols, formaldehyde and dialkanolamines, preferably diethanolamine. Also preferred are aromatic polyamines, for example, 1,2-, 1,3- and 1,4-phenylenediamine and, in particular, 2,3-, 2,4-, 3,4- and 2,6-tolylenediamine, 4,4′-, 2,4′- and 2,2′-diamino-diphenylmethane, polyphenyl-polymethylene-polyamines, mixtures of diamino-diphenylmethanes and polyphenyl-polymethylene-polyamines, as formed, for example, by condensation of aniline with formaldehyde, and mixtures of at least two of said polyamines.

The preparation of polyether-polyols using at least difunctional aromatic initiator molecules of this type is known and described in, for example, DD-A-290 201; DD-A-290 202; DE-A-34 12 082; DE-A-4 232 970; and GB-A-2,187,449; which are incorporated herein by reference in their entireties. The polyether-polyols preferably have a functionality of from 3 to 8, in particular from 3 to 7, and hydroxyl numbers of from 120 to 770, in particular from 200 to 650.

Other suitable polyether-polyols are melamine/polyether-polyol dispersions as described in EP-A-23 987 (U.S. Pat. No. 4,293,657), polymer/polyether-polyol dispersions prepared from polyepoxides and epoxy resin curing agents in the presence of polyether-polyols, as described in DE 29 43 689 (U.S. Pat. No. 4,305,861), dispersions of aromatic polyesters in polyhydroxyl compounds, as described in EP-A-62 204 (U.S. Pat. No. 4,435,537) and DE-A 33 00 474, dispersions of organic and/or inorganic fillers in polyhydroxyl compounds, as described in EP-A-11 751 (U.S. Pat. No. 4,243,755), polyurea/polyether-polyol dispersions, as described in DE-A-31 25 402, tris(hydroxyalkyl) isocyanurate/polyether-polyol dispersions, as described in EP-A-136 571 (U.S. Pat. No. 4,514,426), and crystallite suspensions, as described in DE-A-33 42 176 and DE-A-33 42 177 (U.S. Pat. No. 4,560,708), all such patent publications being incorporated herein in their entireties by reference. Other types of dispersions that may be useful in the present invention include those wherein nucleating agents, such as liquid perfluoroalkanes and hydrofluoroethers, and inorganic solids, such as unmodified, partially modified and modified clays, including, for example, spherical silicates and aluminates, flat laponites, montmorillonites and vermiculites, and particles comprising edge surfaces, such as sepiolites and kaolinite-silicas, are included. Organic and inorganic pigments and compatibilizers, such as titanates and siliconates, may also be included in useful polyol dispersions.

Like the polyester-polyols, the polyether-polyols may be used individually or in the form of mixtures. Furthermore, they may be mixed with the graft polyether-polyols or polyester-polyols and the hydroxyl-containing polyester-amides, polyacetals, polycarbonates and/or phenolic polyols. Examples of suitable hydroxyl-containing polyacetals are the compounds which may be prepared from glycols, such as diethylene glycol, triethylene glycol, 4,4′-dihydroxyethoxydiphenyldimethylmethane, hexanediol, and formaldehyde. Suitable polyacetals may also be prepared by polymerizing cyclic acetals.

Suitable hydroxyl-containing polycarbonates are those of a conventional type, which can be prepared, for example, by reacting diols, such as 1,3-propanediol, 1,4-butanediol and/or 1,6-hexanediol, diethylene glycol, triethylene glycol or tetraethylene glycol, with diaryl carbonates, for example, diphenyl carbonate or phosgene.

The polyester-amides include, for example, the predominantly linear condensates obtained from polybasic, saturated and/or unsaturated carboxylic acids or anhydrides thereof and polyhydric, saturated and/or unsaturated amino alcohols, or mixtures of polyhydric alcohols and amino alcohols and/or polyamines.

Suitable compounds containing at least two reactive hydrogen atoms are furthermore phenolic and halogenated phenolic polyols, for example, resol-polyols containing benzyl ether groups. Resol-polyols of this type can be prepared, for example, from phenol, formaldehyde, expediently paraformaldehyde, and polyhydric aliphatic alcohols. Such are described in, for example, EP-A-0 116 308 and EP-A-0 116 310, which are incorporated herein in their entireties by reference.

In certain preferred embodiments, the polyols may include a mixture of polyether-polyols containing at least one polyether-polyol based on an aromatic, polyfunctional initiator molecule and at least one polyether-polyol based on a non-aromatic initiator molecule, preferably a trihydric to octahydric alcohol.

The formulation of the invention may also include at least one physical or chemical blowing agent, which is intended to foam the flexible polyurethane foam layer and, in some embodiments, the polyurethane heavy layer. This is generally considered to be part of the B-component, though is not necessarily incorporated therein prior to contact between the A-component and B-component. Water may be used as a blowing agent, generally in an amount not exceeding about 10 percent, based on the weight of the polyol or polyol system described hereinabove. Limitation of the amount of water may serve to reduce the overall exotherm of the foam-forming reaction, while at the same time enhancing the mechanical properties of the foam and its dimensional stability at low temperatures.

Among possible selections for a blowing agent are cycloalkanes including, in particular, cyclopentane, cyclohexane, and mixtures thereof; other cycloalkanes having a maximum of 4 carbon atoms; dialkyl ethers, cycloalkylene ethers, and fluoroalkanes; and mixtures thereof. Specific examples of alkanes include, inter alia, propane, n-butane, isobutane, isopentane, and technical-grade pentane mixtures; cycloalkanes, for example, cyclobutane; dialkyl ethers, for example, dimethyl ether, methyl ethyl ether, methyl butyl ether and diethyl ether; cycloalkylene ethers, for example, furan; and fluoroalkanes, which are believed to be broken down in the troposphere and therefore are presently assumed to not damage the ozone layer. The fluoroalkanes include, but are not limited to, trifluoromethane, difluoromethane, difluoroethane, tetrafluoroethane, and hepta-fluoropropane. Also useful are chemical blowing agents such as carbamates and carbamate adducts, such as are described in, for example, U.S. Pat. Nos. 5,789,451 and 5,859,285, which are incorporated herein in their entireties by reference.

The blowing agents may, as noted hereinabove, be used alone or, preferably, in combination with water. The following combinations have proven highly successful and are therefore preferred: water and cyclopentane; water and cyclopentane or cyclohexane; mixtures of cyclohexane and at least one compound from the group consisting of n-butane, isobutane, n- and isopentane, technical-grade pentane mixtures, cyclobutane, methyl butyl ether, diethyl ether, furan, trifluoromethane, difluoromethane, difluoroethane, tetrafluoroethane, and/or heptafluoropropane; water and carbamate adducts; and carbamate adducts with one or more fluoroalkanes and or dialkyl ethers. In particularly preferred embodiments, it is found that including at least one low-boiling compound therein, preferably having a boiling point below about 40° C., which is homogeneously miscible with cyclopentane or cyclohexane, wherein either or these or a mixture thereof is being used, may improve a foam's properties and/or its processability. In particular embodiments the blowing agent or mixture of blowing agents, desirably has a boiling point that is below about 50° C., and preferably from about 30 to about 0° C. Such blowing agents are also described in, for example, EP-A-0 421 269 (U.S. Pat. No. 5,096,933), which are incorporated herein in their entireties by reference.

The sound- and vibration-dampening polyurethane formulations may optionally include further additives or modifiers such as are well-known in the art. For example, surfactants, catalysts, and/or flame retardants may be included. Exemplary thereof are amine catalysts, including any organic compound that contains at least one tertiary nitrogen atom and that is capable of catalyzing the hydroxyl/isocyanate reaction between the A-component and B-component may be used. Typical classes of amines include the N-alkylmorpholines, N-alkyl-alkanolamines, N,N-dialkylcyclohexylamines, and alkylamines where the alkyl groups are methyl, ethyl, propyl, butyl or isomeric forms thereof, and heterocyclic amines. Typical but non-limiting thereof are triethylenediamine, tetramethylethylenediamine, bis(2-dimethylaminoethyl)ether, triethylamine, tripropylamine, tributylamine, triamylamine, pyridine, quinoline, dimethylpiperazine, piperazine, N,N-dimethylcyclohexylamine, N-ethylmorpholine, 2-methylpropanediamine, methyltriethylene-diamine, 2,4,6-tri-dimethylaminomethyl)phenol, N,N′,N″-tris(dimethylaminopropyl)-sym-hexahydrotriazine, and mixtures thereof. A preferred group of tertiary amines comprises bis(2-dimethyl-aminoethyl)ether, dimethylcyclohexylamine, N,N-dimethylethanolamine, triethylenediamine, triethylamine, 2,4,6-tri(dimethylaminomethyl)phenol, N,N′,N-ethyl-morpholine, and mixtures thereof.

One or more non-amine catalysts may also be used in the present invention. Typical of such catalysts are organometallic compounds of bismuth, lead, tin, titanium, iron, antimony, uranium, cadmium, cobalt, thorium, aluminum, mercury, zinc, nickel, cesium, molybdenum, vanadium, copper, manganese, zirconium, and combinations thereof. Included as illustrative examples only are bismuth nitrate, lead 2-ethylhexoate, lead benzoate, lead naphthenate, ferric chloride, antimony trichloride, and antimony glycolate. A preferred organo-tin catalyst may be selected from the stannous salts of carboxylic acids, such as stannous acetate, stannous octoate, stannous 2-ethylhexoate, 1-methylimidazole, and stannous laurate, as well as the dialkyl-tin salts of carboxylic acids, such as dibutyl tin diacetate, dibutyl tin dilaurate, dibutyl tin dimaleate, dioctyl tin diacetate, combinations thereof, and the like.

One or more trimerization catalysts may be used with the present invention. The trimerization catalyst employed may be any known to those skilled in the art which will catalyze the trimerization of an organic isocyanate compound to form the isocyanurate moiety. For typical isocyanate trimerization catalysts, see The Journal of Cellular Plastics, November/December 1975, page 329: and U.S. Pat. Nos. 3,745,133; 3,896,052; 3,899,443; 3,903,018; 3,954,684 and 4,101,465; the disclosures of which are incorporated herein in their entireties by reference. Typical trimerization catalysts include the glycine salts and tertiary amine trimerization catalysts and alkali metal carboxylic acid salts and mixtures of the various types of catalysts. Preferred species within these classes are sodium N-2-(hydroxy-5-nonylphenyl)methyl-N-methylglycinate, N,N-dimethyl-cyclohexylamine, and mixtures thereof. Also included among preferred catalyst components are the epoxides discussed in U.S. Pat. No. 3,745,133, the disclosure of which is incorporated herein in its entirety by reference.

Other additives which may be particularly useful with the present invention are one or more brominated or non-brominated flame retardants. These flame retardants may serve to inhibit the ignition of combustible organic materials, and may also hinder the spread of fire, that is, the time to flashover, thereby providing valuable extra time in the early stages of a fire, during which escape may be possible. In some non-limiting embodiments a brominated polyol having a relatively high viscosity, ranging from about 20,000 centipoise (cP) to about 200,000 cP, and in other embodiments, from about 100,000 cP to about 180,000 cP, may be selected. A suitable flame retardant may be selected from the group consisting of decabromodiphenyl ether (decaBDE) and other polybrominated diphenyl ethers (PBDEs), including, for example, pentabromodiphenyl ether (pentaBDE), octabromodiphenyl ether (octaBDE), tetrabromobisphenol A (TBBPA or TBBP-A), hexabromocyclododecane (HBCD), and combinations thereof. Also included are the brominated organophosphates, such as tris(2,3-dibromopropyl) phosphate (TRIS), bis(2,3-dibromopropyl) phosphate, combinations thereof, and the like. Non-brominated flame retardants include, for example, tris(2-chloroethyl)phosphate, tris(2-chloropropyl)-phosphate, tris(1,3-dichloropropyl)-phosphate, diammonium phosphate, various halogenated aromatic compounds, antimony oxide, alumina trihydrate, polyvinyl chloride, and mixtures thereof.

Dispersing agents, cell stabilizers, and surfactants may also be incorporated into the formulations. Surfactants, including organic surfactants and silicone-based surfactants, may be added as cell stabilizers. Some representative materials are sold under the designations SF-1109, L-520, L-521 and DC-193, which are, generally, polysiloxane polyoxyalkylene block copolymers, such as those disclosed in U.S. Pat. Nos. 2,834,748; 2,917,480; and 2,846,458; the disclosures of which are incorporated herein in their entireties by reference. Also included are organic surfactants containing polyoxyethylene-polyoxybutylene block copolymers such as are described in U.S. Pat. No. 5,600,019, the disclosure of which is incorporated herein in its entirety by reference. Other additives, such as carbon black and colorants, may also be included in the polyurethane formulations. Finally, water or moisture scavengers, such as those based upon or comprising carbodiimides, oxazolidines (ketone and aldehyde types), alkoxysilanes, certain isocyanates such as tosyl isocyanate, and calcium sulfate, as well as certain zeolites and other molecular sieves in general, frequently in a form such as a dispersion in an oil such as castor oil (for example, BAYLITH™ L paste, available from Bayer Corporation), and the like, may also be employed. In certain embodiments these scavengers may be helpful in ensuring a desired density, or achieving full density, in the polyurethane heavy layer in particular.

The description hereinabove is intended to be general and is not intended to be inclusive of all possible embodiments of the invention. Similarly, the examples hereinbelow are provided to be illustrative only and are not intended to define or limit the invention in any way. Those skilled in the art will be fully aware that other embodiments within the scope of the claims are apparent, from consideration of the specification and/or practice of the invention as disclosed herein. Such other embodiments may include use and preparation of molds; identification and proportions of polyurethane starting components such as isocyanate, resin, and blowing agents; mixing and reaction conditions; spray and spray-foam equipment; polymer densities, structures, and other properties; applications of the final NVH products; and the like; and those skilled in the art will recognize that such may be varied within the scope of the claims appended hereto.

### Example

A sound-dampening construction for use in a vehicle passenger compartment is prepared using a very lightweight two-shell epoxy mold. A polyurethane heavy layer formulation is prepared using the components and proportions shown in Table 1.

TABLE 1
Polyurethane Heavy Layer Formulation

| | Parts by weight, |
|---|---|
| | based on |
| | formulation |
| | as a whole |
| A-Component: | |
| PMDI, viscosity about 50 cP at 25° C. | 19 |
| B-Component: | |
| 4700 mw triol, 17% by weight EO capping | 50 |
| TEDA, 33% in MEG (Triethylenediamine | 2 |
| 1,4-diazabicyclo[2.2.2]octane in | |
| N-methyl-D-glucamine) (catalyst) | |
| Zeolite powder (water scavenger) | 3 |
| Barium sulphate (filler) | 88.5 |
| Diethylene glycol (chain-extender) | 4 |

The ratio of the isocyanate to the polyol, without the filler, is about 32.2:100.

A second formulation is prepared, for a flexible polyurethane foam layer. The components of this layer are shown in Table 2.

TABLE 2
Flexible Polyurethane Foam Formulation

| | Parts by weight, |
|---|---|
| | based on |
| | formulation |
| | as a whole |
| A-Component: | |
| PMDI, viscosity about 50 cP at 25° C. | 50 |
| B-Component: | |
| 4700 mw triol, 15% by weight EO capping | 94 |
| Water (blowing agent) | 3 |
| TEDA, 33% in MEG (Triethylenediamine | 3 |
| 1,4-diazabicyclo[2.2.2]octane in | |
| N-methyl-D-glucamine) (catalyst) | |

The ratio of isocyanate to polyol is about 50:100.

To prepare the layered composition, a mold release agent, ACMOS* 37-6001, is first sprayed on the insides of both shells of the mold. (*ACMOS 37-6001 is a trade designation of ACMOS Inc., U.S.A.) The polyurethane heavy layer formulation is then sprayed using a typical dual action sprayer that meters polyol to isocyanate in an appropriate volume ratio, against the inside surface of the mold shells at a rate of about 230 grams per second for about 30 seconds, resulting in a molded polyurethane heavy layer of about 6.7 kg, having a thickness of about 3 mm and a density of about 2.2 kg/m³. During spraying the formulation is maintained at a temperature of from about 20 to about 60° C.

Almost immediately thereafter, a flexible polyurethane foam layer is sprayed at a rate of about 60 grams per second for about 20 seconds, until a layer of about 1.140 kg, having an average thickness of about 1.9 cm (ranging from about 1.5 cm to about 2.5 cm), and a density of about 60 kg/m³, is formed in the mold directly against the polyurethane heavy layer. Final thickness may vary from about 1.5 cm to about 2.5 cm. During spraying the flexible foam formulation is kept at a temperature of from about 20 to about 40° C.

The mold lid is immediately closed and the two foam layers are allowed time to complete foaming and polymerization. The mold is maintained at a temperature that ranges from about 30 to about 50° C. Total cycle time, from initiation of spraying the polyurethane heavy layer to demold of the layered composition, is about 2 minutes. The demolded layered construction exhibits integral bonding between the two foam layers and is suitable as an NVH material.

What is claimed is:

1. A method of preparing a layered composition comprising, in non-ordered steps, spraying or spray-foaming at least one polyurethane heavy layer, and spray-foaming at least one flexible polyurethane foam layer, under conditions such that the layers form an integral layered composition without use of an adhesive between the polyurethane heavy layer and the flexible polyurethane foam layer.

2. The method of claim 1 wherein the polyurethane heavy layer comprises a polyurethane having a density from about 500 kg/m³ to about 9000 kg/m³, and the flexible polyurethane foam layer comprises a polyurethane foam having a density from about 15 kg/m³ to about 250 kg/m³.

3. The method of claim 1 wherein the polyurethane heavy layer or the flexible polyurethane foam layer is sprayed or spray-foamed against a substrate selected from the group consisting of a mold surface, a substrate that becomes part of the layered composition, and a substrate that does not become part of the layered composition.

4. The method of claim 3 wherein the mold surface is comprised by a one-part mold or a two-part mold; the substrate that becomes part of the layered composition is selected from the group consisting of a metal sheet, a metal foil, a paper, a scrim, and combinations thereof; and the substrate that does not become part of the layered composition is a conveyor device.

5. The method of claim 3 wherein a release agent is applied to a substrate prior to spraying or spray-foaming the polyurethane heavy layer or the flexible polyurethane foam layer against or onto it.

6. The method of claim 4 wherein the scrim comprises a textile selected from the group consisting of polypropylene, polyolefin, and polyethylene fibers that are woven, non-woven, or tufted.

7. The method of claim 1 further comprising spraying or spray-foaming additional layers above or under the layered composition, wherein the additional layers are the same as, or different from, the polyurethane heavy layer or the flexible polyurethane foam layer.

8. A layered composition comprising at least one polyurethane heavy layer and, bonded integrally thereto without use of an adhesive, at least one flexible foam polyurethane layer.

9. The layered composition of claim 8 wherein the polyurethane heavy layer comprises a polyurethane having a density from about 500 kg/m³ to about 9000 kg/m³, and the flexible polyurethane foam layer comprises a polyurethane foam having a density from about 15 kg/m³ to about 250 kg/m³.

10. The layered composition of claim 9 wherein the filler is selected from the group consisting of inorganic oxides, sulfates, silicates, clays, carbonates, wollastonite, titanates, and combinations thereof.

11. The layered composition of claim 9 further comprising a substrate wherein the substrate is selected from the group consisting of a metal sheet, a metal foil, a paper, a scrim, and combinations thereof.

12. The layered composition of claim 11 wherein the scrim comprises a textile selected from the group consisting of polypropylene, polyolefin, and polyethylene fibers that are woven, non-woven, or tufted.

13. The layered composition of claim 8 further comprising additional layers above or under the layered composition, wherein the additional layers are the same as, or different from, the polyurethane heavy layer or the flexible polyurethane foam layer.

14. A layered composition prepared by a method comprising, in non-ordered steps, spraying or spray-foaming at least one polyurethane heavy layer, and spray-foaming at least one flexible polyurethane foam layer, under conditions such that an integral layered composition is formed without use of an adhesive between the polyurethane heavy layer and the flexible polyurethane foam layer.

15. The layered composition of claim 14 further comprising a substrate selected from the group consisting of a metal sheet, a metal foil, a paper, a scrim, and combinations thereof, wherein the substrate is adhered to a layer without use of an adhesive.
